(19) United States
(12) Patent Application Publication
(10) Pub. No.: US 2020/0258060 A1
(43) Pub. Date: Aug. 13, 2020

(54) METHOD AND DEVICE FOR APPORTIONMENT BY A CONVERSATIONAL AGENT OF AN EXPENDITURE INCURRED BY A USER WITHIN A GROUP OF USERS

(71) Applicant: ORANGE, Paris (FR)

(72) Inventors: Emmanuel Le Huerou, Chatillon Cedex (FR); Francois Toutain, Chatillon Cedex (FR); Marie-Helene Froger, Chatillon Cedex (FR)

(21) Appl. No.: 16/492,856

(22) PCT Filed: Jun. 6, 2019
(86) PCT No.: PCT/FR2019/051349

§ 371 Date: Sep. 10, 2019

(30) Foreign Application Priority Data
Jun. 22, 2018 (FR) 1855608

(51) Int. Cl. G06Q 20/10; H04L 12/58; G06Q 40/02

(52) U.S. Cl. CPC G06Q 20/102; G06Q 40/02; H04L 51/046

(57) ABSTRACT

A method of apportionment between a first and at least one second user of a banking operation carried out by the first user. The method includes: receiving an apportionment request originating from a terminal of the first user, the apportionment request including an identifier of the first user, an identifier of a group of users of an instant messaging service, and an amount to be apportioned; obtaining a characteristic of the identified group of users; calculating according to an apportionment rule and the characteristic of the group of users; apportionment of the amount among the users belonging to the group; updating, according to the calculated apportionment, a balance associated with each of the users of the group, and sending an instant message addressed to at least one member of the group, including at least the updated balance associated with the at least one member of the group.

### CROSS-REFERENCE TO RELATED APPLICATIONS

This Application is a Section 371 National Stage Application of International Application No. PCT/FR2019/051349, filed Jun. 6, 2019, the content of which is incorporated herein by reference in its entirety, and published as WO [TBD] on [Not Yet Published], not in English.

### PRIOR ART

The sharing of an expenditure between several people is a problem frequently encountered by groups of friends during a journey, when leaving a restaurant or else within the framework of a co-rental.

Diverse tools are at one's disposal to facilitate this sharing. For example, smartphone applications exist which make it possible to record an expenditure which is performed by a user and to automatically calculate an apportionment of the expenditure among several other people. In this way, at any moment the members of a group know to whom they owe money, and the amount that they must reimburse. The person that incurred the expenditure does not need to ask for reimbursement directly from the other people, it is the application which is responsible for reminding the others that reimbursement is expected.

Such applications sometimes allow the users to associate a bank account so that money transfers can be carried out easily from the apportionment application in order to perform reimbursements.

However, these applications exhibit a drawback: the various people must all use a compatible application so that the expenditures can be apportioned amongst them. It is furthermore necessary to input particulars relating to each of the people constituting the group, and optionally banking information so that bank money transfers can be carried out easily. These various configuration steps constitute a brake on the use of these techniques, in particular when the need is occasional.

Therefore, a need exists for a technique making it possible to apportion expenditures performed by a person between various members of a group of person which does not exhibit the aforementioned drawbacks.

### SUMMARY OF THE INVENTION

To this effect, there is proposed a method of apportionment between a first and at least one second user of the amount of a banking operation carried out by the first user, the first and second users forming a group of users, the method being characterized in that the group of users is a chat group configured in an instant messaging service and in that it comprises the following steps:
Reception of an apportionment request originating from a terminal of the first user, the apportionment request comprising at least:
   an identifier of the first user,
   an identifier of a group of users of an instant messaging,
   an amount to be apportioned,
Obtaining of at least one characteristic of the identified group of users,
Calculation according to an apportionment rule and of the at least one characteristic of the group of users, of an apportionment of said amount among the users belonging to the group,
Updating, according to the calculated apportionment, of a balance associated with each of the users of the group, and
Sending of an instant message addressed to at least one member of the group, the message comprising at least one indication according to which a balance associated with each of the users has been updated.

The method thus makes it possible to apportion an expenditure or a bill between users of a chat group existing on an instant messaging platform. Because the apportionment is done among the users of a pre-existing group, the users do not have to input additional information. More and more instant messaging services are being used by groups of friends to prepare a journey or a week-end together. Thus, such a chat group created for the occasion can also be used to apportion the expenditures incurred by each for the preparations or during the trip.

The method is for example implemented by a conversational agent (“chat-bot” in English) that can intervene in the chat group by sending messages addressed to the group. In this way, when a user incurs an expenditure, the conversational agent calculates an apportionment and transmits their balance to all the members of the group, in the form of an instant message.

For example, a user of the group can simply send a message addressed to the group while indicating the amount of an expenditure. The conversational agent associated with the chat group intercepts the message, calculates an apportionment and transmits a message indicating the sums owed by each of the members, for example in the form of a zero, positive or negative balance.

According to another example, the apportionment request is received from a bank server or a banking application hosting banking services associated with the first user.

The calculated apportionment takes account of the number of individuals making up the group. Thus, when a person is added or deleted from the group, the calculation of the future apportionments is automatically adapted to the new configuration of the group.

Within the framework of this description, by conversational agent (or “chatbot”) is meant an automaton implemented by a server and adapted to take part in instant messaging conversations. A conversational agent can be added to a chat group to exchange messages with the group. Such a conversational agent can for example interpret commands or key words included in messages that it receives and dispatch messages in response to user prompts or to particular events. Such conversational agents are generally implemented by computer programs executed on servers having communication interfaces at their disposal which are adapted to receive and dispatch instant messages, such as SMSs, MMSs or other types of messages, such as for example messages compliant with the RCS standard or with any other instant messaging protocol.

Moreover, the term “balance” is to be understood here as the positive difference (debtor balance) or negative difference (creditor balance) between the total of the debit and the total of the credit of an account associated with a user. Thus, a user's balance is the amount they are owed or that they owe in relation to the group.

According to a particular apportionment, the method is such that the step of sending a message to at least one member of the group is conditioned by the prior receipt of a message originating from said at least one member of the group.

A user's balance, that is to say what they owe or are owed in relation to the other members of the chat group, is thus sent only when prompted for it. Such a provision enables a user to know their balance when they request it.

According to a particular embodiment, the method is such that the apportionment request received furthermore comprises a subset of users belonging to said group, the apportionment being calculated and the balances being updated solely for said subset of users.

The method thus makes it possible not to take account of one or more people of the group when calculating the apportionment. Such a provision makes it possible for example not to take into account children when apportioning expenditures if the group comprises children and adults.

According to a particular embodiment, the method is such that it furthermore comprises a step of transmitting, to a server hosting banking services of the first user, a message comprising the balances associated with the various users belonging to the group.

The zero, positive or negative balances associated with the various members of the chat group and updated during the calculation step are transmitted to a banking service of the user who is requesting an apportionment. In this way, a bank account management application can display in association with an operation statement, monies owing or owed in relation to certain people. The tracking of a budget is thus improved.

According to a particular embodiment, the instant message addressed to at least one member of the group is sent to each of the members of the group, the message comprising the balance associated with each member of the group.

Thus, as soon as an apportionment request is processed by the conversational agent, the group's member users receive a summary of what they owe or are owed as well as monies owing to or owed by the other members of the chat group.

According to a particular embodiment, the method is such that it furthermore comprises a step of generating and sending an instant message addressed to the group, the message comprising an identifier of the first user and an amount of the incurred expenditure.

When an instant message is sent to the group, it is received by each member. Thus, when a user requests the apportionment of the amount of a banking operation, the members of the group within which the apportionment must be apportioned are alerted. The message can also contain the subject of the expenditure so that the other members of the group can know the origin of the debts for which they are liable.

According to another aspect, and in a manner corresponding to the method of apportionment, the invention relates to a method of requesting apportionment of an expenditure incurred by a user, the method being such that it comprises the following steps:
Selection of a banking operation on the basis of a statement of banking operations,
Sending of a message requesting apportionment to a conversational agent associated with an instant messaging service, the apportionment request comprising at least:
   an identifier of the user,
   an identifier of a group of users of an instant messaging,
   an amount to be apportioned, and
reception of an instant message intended for said group of users comprising at least one balance associated with at least one member of the group.

A user can thus request simply, from a communication terminal such as a smartphone comprising for example a bank account management application, that an expenditure which appears on his account statement be apportioned among the members of a chat group existing on an instant messaging service.

According to a particular embodiment, the method of requesting apportionment is such that the selection of a banking operation is carried out according to a characteristic of the payment means used to carry out the operation.

It is thus possible to perform an apportionment request in an automatic manner when a banking operation satisfies certain criteria, such as for example when the operation was carried out on the basis of a particular payment means, or the operation was carried out on a particular date. Such a provision simplifies the sending of an apportionment request. Thus, it is possible to configure the user's terminal in such a way that all the payments made by means of a particular bank card over a given period give rise automatically to an apportionment request.

According to a particular embodiment, the method of requesting apportionment is such that it furthermore comprises a prior step of obtaining an identifier of an instant messaging user group, the user group comprising at least the first user.

It is thus proposed to interrogate an instant messaging server so as to obtain a list of chat groups to which the first user is party. The user has merely to select the group within which he wishes to apportion the expenditure.

The invention also relates to a device for apportionment between a first and at least one second user of the amount of a banking operation carried out by the first user, the first and second users forming a group of users, the device being characterized in that the group of users is a chat group configured in an instant messaging service and in that it comprises:
A reception module, adapted to receive an apportionment request originating from a terminal of the first user, the apportionment request comprising at least:
   an identifier of the first user,
   an identifier of a group of users of an instant messaging,
   an amount to be apportioned,
A module for obtaining at least one characteristic of the identified group of users,
A calculator, adapted to calculate an apportionment of the amount among the users of the group according to an apportionment rule and the at least one characteristic of said group,
A module for updating, according to the calculated apportionment, a balance associated with each of the users of the group,
A communication module adapted to send an instant message addressed to at least one member of the group, the message comprising at least the updated balance associated with said at least one member of the group.

According to a particular embodiment, the invention relates to a server comprising an apportionment device such as described hereinabove.

The invention also relates to a device for requesting apportionment of an expenditure incurred by a user, the device being such that it comprises:
a module for selecting a banking operation on the basis of a statement of banking operations,
a module for sending a message requesting apportionment to a conversational agent associated with an instant messaging service, the apportionment request comprising at least:
   an identifier of the user,
   an identifier of a group of users of an instant messaging,
   an amount to be apportioned, and
a module for receiving an instant message intended for said group of users comprising at least one balance associated with at least one member of the group.

According to a particular embodiment, the invention relates to a communication terminal comprising an apportionment requesting device such as described hereinabove.

In a particular embodiment, the various steps of the method of apportionment and/or the various steps of the method of requesting apportionment according to the invention are determined by computer program instructions.

Consequently, the invention also envisages a computer program on an information medium, this program being able to be implemented in a server connected to a communication network and/or more generally in a computer, this program comprising instructions adapted to the implementation of the steps of a method of apportionment and/or of a method of requesting apportionment such as are described hereinabove.

This program can use any programming language, and be in the form of source code, object code, or of code intermediate between source code and object code, such as in a partially compiled form, or in any other desirable form.

The invention also envisages an information medium or recording medium readable by a computer, and comprising instructions of a computer program such as is mentioned hereinabove.

The information medium or recording medium can be any entity or device capable of storing the program. For example, the medium can comprise a storage means, such as a ROM, for example a CD ROM or a microelectronic circuit ROM, or else a magnetic recording means, for example a diskette (floppy disk) or a hard disk.

Moreover, the information medium or recording medium can be a transmissible medium such as an electrical or optical signal, which can be conveyed via an electrical or optical cable, by radio or by other means. The program according to the invention can be in particular downloaded over a network of Internet type.

Alternatively, the information medium or recording medium can be an integrated circuit in which the program is incorporated, the circuit being adapted to execute or to be used in the execution of the method in question.

It is also possible to envisage, in other embodiments, that the method of apportionment and the server according to the invention exhibit in combination all or some of the aforementioned characteristics.

### LIST OF FIGURES

Other characteristics and advantages of the methods will become more clearly apparent on reading the following description of a particular embodiment given by way of simple illustrative and non-limiting example, and of the appended drawings, among which:

FIG. 1 illustrates a network architecture adapted for the implementation of the methods of apportionment and of requesting apportionment according to a particular embodiment of the invention,

FIG. 2 illustrates various steps of a method of requesting apportionment according to a particular embodiment,

FIG. 3 illustrates various steps of a method of apportionment according to a particular embodiment,

FIGS. 4a to 4d represent various displays on a communication terminal implementing the method of requesting apportionment according to a particular embodiment,

FIG. 5 is a table representing the evolution of balances associated with users of a group subsequent to various apportionment requests,

FIG. 6 illustrates an architecture of a device adapted to implement a method of apportionment according to a particular embodiment, and

FIG. 7 illustrates an item of hardware of a device adapted to implement a method of requesting apportionment, in a particular embodiment.

### DETAILED DESCRIPTION

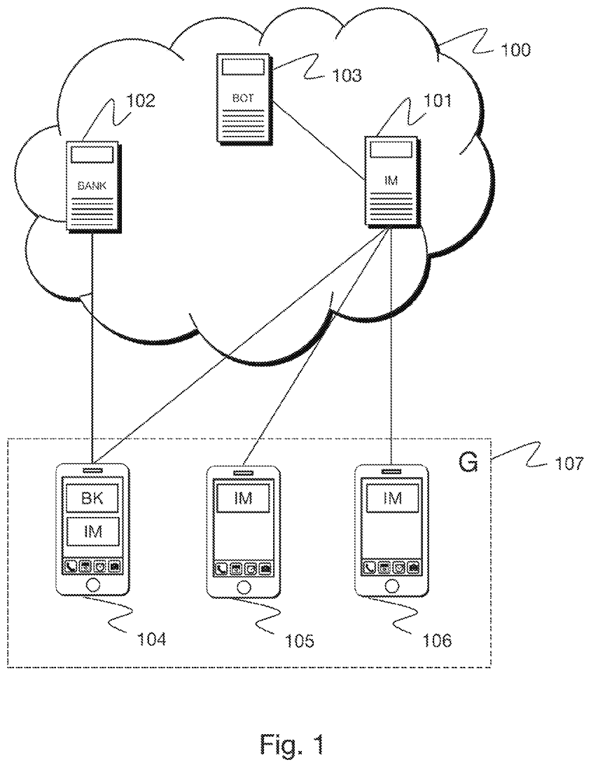

FIG. 1 represents a network architecture comprising a communication network 100, for example an Internet network. The network 100 comprises an instant messaging server 101. Such a server is known to the person skilled in the art and allows users to exchange messages compliant with an instant messaging protocol. FIG. 1 also shows three communication terminals 104, 105 and 106, which are for example smartphones adapted to communicate with the messaging server 101 through the communication network 100. The terminals 104 to 105 are adapted to exchange messages with the instant messaging server 101 compliant with an instant messaging protocol such as RCS (Rich Communication Suite), SIP SIMPLE, or else Jabber. The messaging server 101 is for example a commercial messaging service, such as the well-known services “Skype™” or “What's App™”, with which the terminals can exchange messages. To exchange messages with the server 101, the terminals 104 to 105 comprise for example an application IM implementing a compatible protocol.

The network 100 furthermore comprises a server implementing a conversational agent 103. A conversational agent is generally implemented by a computer program executed by a server and configured to exchange messages with users of an instant messaging service. In this instance, the terminals 104 to 106 can send instant messages to the conversational agent 103 and receive messages generated and sent by the conversational agent 103 by way of the messaging server 101.

In a known manner, messaging services offer users the possibility of forming chat groups. Chat groups are generally created by a first user, who can then invite other users of the messaging service to be party to the group. In FIG. 1, the users of the terminals 104 to 106 form a group 107. When a message is sent by a user addressed to such a group, the message is generally relayed by the messaging server to all the members of this group, except for the sender of the message. Thus, If the terminal 104 transmits a message M addressed to the group, the message will be received by the terminals 105 and 106. The advantage of such a group is that a user does not have to explicitly designate all the addressees of the message when sending a message. Likewise, when the terminal 105 responds to the message M, the response message R is received by the terminals 104 and 106. The exchanges between several users are then facilitated.

Group chat services offered by instant messaging platforms are having growing success today. They allow for example friends using one and the same messaging service to easily plan a journey or an outing.

Chat groups also make it possible to invite one or more conversational agents into a group. When a conversational agent is invited into a chat group, it can send messages addressed to the group, which will be received by the group's member users. Likewise, the conversational agent can receive messages addressed to the group. The messaging server processes the messages exchanged by the conversational agent in the same manner as if it originated from a conventional user.

It may be noted that certain messaging services offer a user of a group the possibility of sending a message to a particular user of the group, by designating same explicitly when sending the message, the members of the group other than the explicitly indicated addressee not receiving the message.

The communication network 100 finally comprises a bank server 102. The bank server 102 hosts for example banking services subscribed to by the user of the terminal 104. In particular, the server 102 offers the user of the terminal 104 the possibility of consulting a statement of operations on a bank account which he owns or of performing bank money transfers. To do this, the terminal 104 comprises for example an application BK configured to establish a secure connection with the bank server 101 and to download a statement of operations so as to allow consultation thereof from the terminal 104. Such applications generally offer other services, such as for example the possibility of performing bank money transfers, of ticking off expenditures or of classing operations.

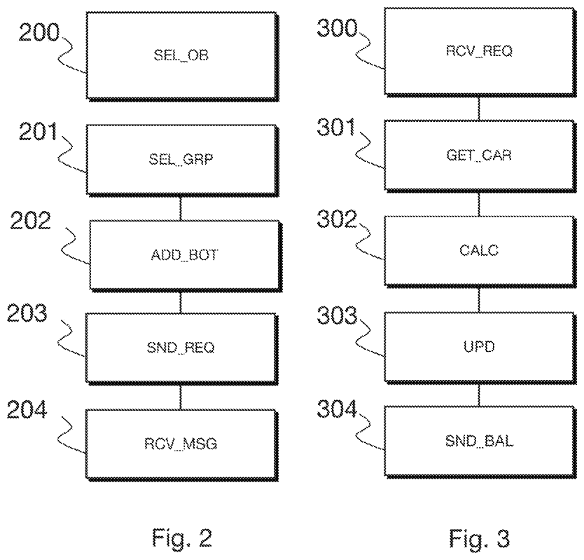

The methods of apportionment and of requesting apportionment will now be described with reference to FIGS. 2 and 3.

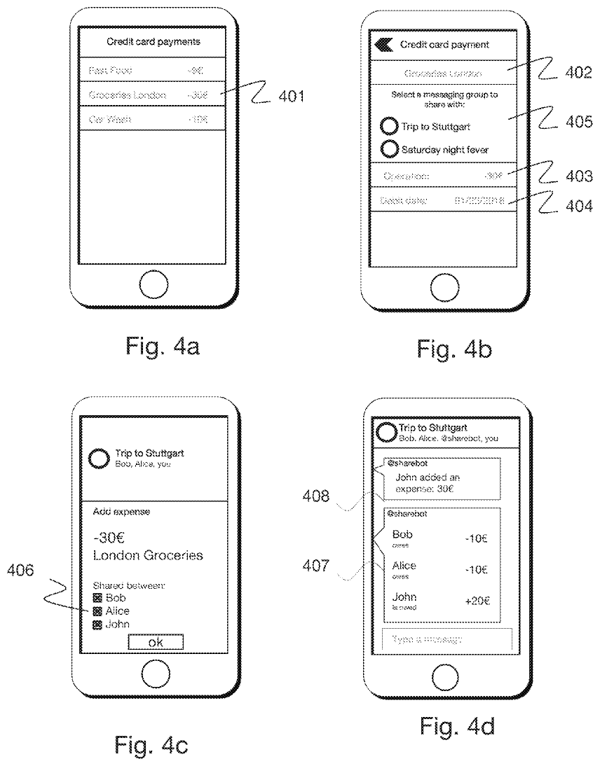

During a step 200, the user of the terminal 104 uses a banking application of the terminal to consult a statement of banking operations which is made available by the bank server 102. FIG. 4a illustrates an exemplary display in the form of a list of a set of banking operations associated with a bank account of the user of the terminal 104. The user of the terminal 104 then selects a banking operation 401 from the list by means of a touchscreen of the terminal.

Selecting the banking operation 401 makes it possible to access the details of the operation. FIG. 4b illustrates an exemplary display of the detailed information relating to the selected operation, for example the heading 402 of the operation, its amount 403 or its date 404.

The banking application BK screen represented in FIG. 4b is noteworthy in that it comprises a zone 405 enabling the user to select a chat group hosted by the messaging server 101. To do this, the terminal 104 transmits a message to the messaging server 101, the message comprising an identifier of the user of the terminal on the messaging service and a query to obtain a list of the groups to which he belongs. On receipt of this message, the terminal displays in a suitable user interface the received list of groups. FIG. 4b shows the groups “Trip to Stuttgart” and “Saturday Night Fever” to which the user is party.

The user selects one of the groups displayed in step 201 to request that the banking operation whose details are currently being consulted be apportioned among the members of the selected group. For example, by touching the screen at the location “Trip To Stuttgart”, the user can choose to request that the expenditure be apportioned among the members of the chat group “Trip to Stuttgart”. This group corresponds for example to the group 107 of FIG. 1, comprising the terminals 104 to 106.

According to a particular embodiment, selecting a particular group causes the sending in step 202 of a first message addressed to the messaging server 101. This first message comprises at least one identifier of the selected group and a command to add the conversational agent 103 to the chat group selected, for example to the group 107, if it has not already been added beforehand.

According to a particular embodiment, the selecting of a group by the user causes during a step 203 the dispatching of an apportionment request message addressed to the conversational agent 103, the message comprising at least one identifier of the user of the terminal 104, an identifier of the selected group 107, and an amount of an operation to be shared. Of course, such a message can comprise other information, such as for example a comment, a date, a type of operation, or any other desirable item of data. In particular, the message can comprise an indication according to which the addressee of the message is the conversational agent 103.

The message is for example a message complying with the instant messaging protocol implemented by the server 101. The terminal transmits this message to the messaging server which is responsible for relaying it to the conversational agent identified in the message.

According to another particular embodiment, the terminal 104 transmits the message to the conversational agent 103 by means of a protocol distinct from the messaging protocol implemented by the server 102. For example, the conversational agent can offer an http interface through which a terminal such as the terminal 104 can transmit commands to the conversational agent. Such a command message also comprises at least one identifier of the user of the terminal 104, an identifier of the chat group 107 selected and an amount to be apportioned.

According to a particular embodiment, the selecting of the banking operation to be apportioned is carried out automatically by the bank server 102 for the operations corresponding to a particular criterion. For example, an operation to be apportioned is selected according to a characteristic of the payment means used to carry out the operation, a date, a place or a day of the week. Thus, the operations performed with the aid of a particular payment means, for example those carried out with a particular credit card give rise, when they are accounted by the bank server, to the sending of a request for apportionment within a group associated beforehand with the payment means.

To do this, the bank server 102 comprises a database in which selection criteria are stored in association with identifiers of chat groups on an instant messaging platform. When an operation is accounted, or on another determined date, the bank server 102 transmits for the account of the user of the terminal 104 a message requesting apportionment of the amount of the operation addressed to the conversational agent 103 associated with the chat group corresponding to the selection criterion hosted by the messaging platform 101.

In a particular embodiment, step 201 of selecting a chat group comprises a sub-step of selecting a subset of member users of the chat group. FIG. 4c illustrates a screen of the terminal 104 displayed when the user has selected a group with which to share an operation. In this example, selecting the group “Trip to Stuttgart” on the screen represented in FIG. 4b causes the displaying of the screen represented in FIG. 4c. During this sub-step, the terminal obtains a list of the member users of the selected group and displays on the screen of the terminal the list 406 of the users obtained. The user of the terminal 104 can select or deselect users of the list so as to form a subset of users. Identifiers of the users selected are added to the apportionment request message sent in step 203. It is thus possible to exclude one or more users from the apportionment request.

The conversational agent 103 implements the method of apportionment according to a particular embodiment. To do this, the conversational agent 103 comprises for example a processor and a memory in which are loaded, from a storage medium such as a hard disk, instructions configured to implement the various steps of the method of apportionment which are described hereinafter.

During a step 300, the conversational agent 103 receives the apportionment request message sent by the terminal 104. The message received comprises at least one identifier of the user of the terminal 104 that sent the apportionment request message, an identifier of the selected group, in respect of which the apportionment is requested, from among the users, and the amount of the operation to be apportioned.

The message received can be an instant message sent by the terminal 104 to the messaging server 101 and relayed to the conversational agent. It may also be an http query received by a module for processing http queries of the server 101, such as for example by a Web server of the server 101.

In step 301, the conversational agent 103 obtains at least one characteristic of the identified group of users. To do this, the conversational agent transmits for example a service message to the messaging server 101 comprising the identifier of the group and a command for obtaining information relating to the group. The characteristics received in response comprise for example the name of the group, the number of its members, its date of creation, or else names and images associated with each member user of the group.

During a step 302, the conversational agent calculates according to an apportionment rule and according to at least one characteristic, obtained in step 301, of the group of users, an apportionment of the amount to be apportioned among the users belonging to the group.

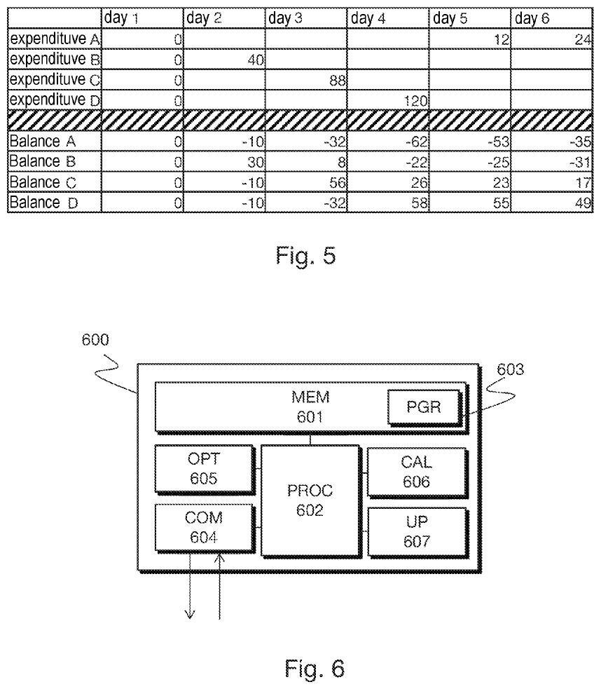

According to a particular embodiment, the apportionment rule is an equitable apportionment rule, according to which the contribution of each user to an expenditure corresponds to the amount of the expenditure, divided by the number of users. FIG. 5 shows how it is possible to apportion expenditures incurred by users A, B, C and D day after day. It is noted that user B incurs an expenditure of 40€ on the second day. The balances corresponding to the users A, B, C and D on applying the apportionment rule are respectively −10€, 30€, −10€ and −10€. Stated otherwise, user B is owed 30€, and users A, C and D owe 10€. FIG. 5 shows the evolution of the balance of each of the users according to the expenditures incurred day after day on applying the same apportionment rule. It is noted that the balance associated with each user subsequent to the calculation of a new apportionment takes account of the previous apportionment operations.

As a variant, other apportionment rules may be envisaged. For example, the contribution of each user of the group may be weighted according to a predefined criterion, such as for example according to the number of people for whom a user is responsible during a trip or a level of income.

The apportionment can be carried out not only according to an apportionment rule, but also according to a characteristic of the group. In particular, the apportionment is carried out according to a number of users of the group, or else according to a date of arrival and/or of departure of a person of the group, or another criterion associated with a user of the group, such as for example the age of a user. For example, the apportionment may take account only of the members of the group who are more than 18 years old, the minor users then being disregarded from the apportionment operations.

In step 303, the conversational agent updates, according to the calculated apportionment, a balance associated with each of the group's users. To do this, the conversational agent 103 can comprise a database in which balances are stored in association with user and group identifiers. Thus for example, the balances A, B, C and D, represented in FIG. 5, calculated according to the equitable apportionment rule described hereinabove, are stored by the conversational agent and associated with a user identifier on the messaging platform, and with a chat group identifier. In this way, one and the same individual belonging to several groups can be associated with various balances.

During a step 304, the conversational agent generates an instant message comprising at least one updated balance associated with at least one member of the group and transmits the message to at least one member of the group. For example, the conversational agent 103 generates a message comprising the name of the users of the terminals 14, 15, and 16. The message furthermore comprises, for each of these users, the balance updated and stored subsequent to the application of the apportionment rule. Such a message corresponds for example to the message 407 represented in FIG. 4d.

The message thus generated is sent by the conversational agent addressed to the group 107 so that it is distributed to the terminals 104, 105 and 106.

According to a particular embodiment, the conversational agent furthermore transmits to the bank server 102 a message comprising the calculated apportionment, that is to say the monies owed by or owing to each member of the group in regard to the operation for which an apportionment was requested. The bank server can thus associate an apportionment with a banking operation featuring on a statement of operations of the user of the terminal 104. The user of the terminal 104 can thus easily know, for each apportioned operation appearing on his account statement, the sums to be collected or reimbursed by this or that person.

In a particular embodiment, the step of sending a message to at least one member of the group is conditioned by the prior receipt of a message originating from said at least one member of the group. Thus, although the balances of the users of the group are calculated and updated on receipt of an apportionment request, each user's balance is transmitted to the members of the group only when one of them requests it. For example, the prior message may be a message written by a user in natural language, for example a message sent by the user of the terminal 105 and comprising the character string “My Balance”. The message is received by the conversational agent and interpreted by an interpreter, and then if the interpreter detects a particular command, the conversational agent transmits to the terminal 105 the balance associated its user. In the same manner, a message comprising the terms “All the balances” may trigger the sending of a message comprising the balances of all the users of the group, the message being able to be sent just to the user who requested it, or to all the users.

According to a particular embodiment, the apportionment request received in step 300 furthermore comprises a subset of users belonging to said group, the apportionment being calculated for said subset of users. Thus, when the apportionment request message comprises a subset of users, the apportionment rule is applied to the subset of users, rather than to the whole set of members of the group. Only the balances of the users whose identifier appears in the apportionment request message are affected by the new apportionment.

According to a particular embodiment, the method furthermore comprises, subsequent to the receipt of a request for apportionment of the amount of a banking operation, a step of generating and sending an instant message addressed to the members of the group, the message comprising at least one identifier of the first user and an amount of the expenditure incurred. Stated otherwise, when the conversational agent 103 receives an apportionment request originating from the terminal 104, it transmits a message addressed to the group, the message comprising at least one identifier of the user who made the apportionment request and an amount associated with this apportionment. Such a message corresponds for example to the message 408 represented in FIG. 4d. The receipt of such a message by the users of the group allows them to be aware of an operation effected by a user of the group for the account of the users of the group.

In step 204, the terminal 104 receives the message sent by the conversational agent in step 304. The message received comprises at least one updated balance associated with at least one member of the group. Preferably, the message comprises the list of users of the group, and for each of these users, an amount owed or an amount owing in regard to the other members of the group. The aggregated amounts owed or owing, associated with the users of the group, correspond to a balance for each of the users. For example, the terminal 104 receives by way of the instant messaging application IM a message such as the message 407 illustrated in FIG. 4d. Such a message comprises a balance associated with each user. The message having been generated and transmitted to the chat group by the conversational agent, it is also received by the terminals 105 and 106.

The methods of apportionment and of requesting apportionment thus make it possible to exploit chat groups pre-existing on an instant messaging platform to manage common pots or expenditures incurred by a user for the account of a group of friends. Management of shared expenditures is greatly facilitated thereby.

FIG. 6 represents the architecture of a device 600 adapted to implement the method of apportionment, according to a particular embodiment of the invention.

The device 600 comprises a data processing module comprising a storage space 601, for example a memory (MEM), a processing unit 602, equipped for example with a microprocessor (PROC), and driven by the computer program (PGR) 603 implementing the method of apportionment such as described previously with reference to FIG. 3.

On initialization, the code instructions of the computer program 603 are for example loaded into memory before being executed by the processor of the processing unit 602. The microprocessor of the processing unit 602 implements, according to the instructions of the computer program 603, the steps of the method of apportionment, and in particular the steps of receiving an apportionment request originating from a terminal of the first user, the apportionment request comprising at least one identifier of the first user, an identifier of a group of users of an instant messaging, and an amount to be apportioned, of obtaining at least one characteristic of the identified group of users, of calculating according to an apportionment rule and the at least one characteristic of the group of users, an apportionment of said amount among the users belonging to the group, of updating, according to the calculated apportionment, a balance associated with each of the users of the group, and of sending an instant message addressed to at least one member of the group, the message comprising at least the updated balance associated with said at least one member of the group.

To do this, the device comprises a reception module 604, adapted to receive an apportionment request originating from a terminal of the first user, the apportionment request comprising at least one identifier of the first user, an identifier of a group of users of an instant messaging, and an amount to be apportioned. Such a reception device is for example a communication interface COM, such as an Ethernet or WiFi interface, driven by computer program instructions adapted to be executed by the processor PROC of the device and configured to receive and interpret a message compliant with an instant messaging protocol.

The device 600 furthermore comprises a module 605 for obtaining at least one characteristic of the identified group of users. Such a module is for example implemented by computer program instructions adapted to be executed by a processor such as the processor 602 and configured to dispatch, by way of the communication module 604, a service message to a messaging server, the message comprising a command for obtaining characteristics relating to a group whose identifier is included in the message. The instructions are furthermore configured to receive, by way of the communication module 604, a response message comprising characteristics of the identified group, such as the number of member user of the group, their names, the date of creation of the group or of addition of the members.

The device 600 also comprises a calculator 606, adapted to calculate an apportionment of the amount among the users of the group according to an apportionment rule and the at least one characteristic of said group. The module is for example implemented by computer program instructions adapted to be executed by the processor 602 and configured for example to apportion an amount in equal share among the users of the group. The apportionment rule applied is for example a division of the amount of the operation to be apportioned by the number of users obtained via the characteristics of the group.

The module 600 also comprises a module 607 for updating, according to the calculated apportionment, a balance associated with each of the users of the group. The module 607 can also be implemented by computer program instructions configured to add together the share calculated by the calculator 606 for each of the users with a residual balance stored for each user in a database of the device, the instructions furthermore being configured to store the new balance obtained.

Finally, the communication module 604 is furthermore configured to send an instant message addressed to at least one member of the group, the message comprising at least the updated balance associated with said at least one member of the group. To do this, the module 604 can be driven by computer program instructions configured to obtain, through a query to the database in which are stored the balances associated with the users of the group, the updated balance of at least one user and for transmitting by way of an instant message, the balance obtained and an identifier of the user with which the balance is associated.

In a particular embodiment, the device 600 comprises instructions adapted to be executed by the processor 602 and configured to implement any one of the various particular embodiments of the above-described method of apportionment.

According to a particular embodiment, the device is integrated into a server such as a messaging server, a bank server or a server hosting a conversational agent.

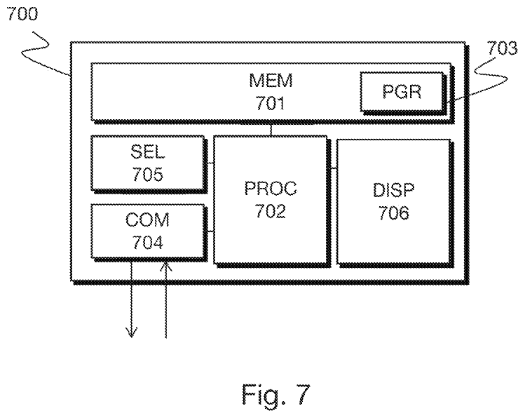

FIG. 7 represents the architecture of a device 700 adapted to implement the method of requesting apportionment, according to a particular embodiment of the invention.

The device 700 comprises a data processing module comprising a storage space 701, for example a memory (MEM), a processing unit 702, equipped for example with a microprocessor (PROC), and driven by the computer program (PGR) 703 implementing the method of requesting apportionment such as described previously with reference to FIG. 2.

On initialization, the code instructions of the computer program 603 are for example loaded into memory before being executed by the processor of the processing unit 602. The microprocessor of the processing unit 602 implements, according to the instructions of the computer program 603, the steps of the method of requesting apportionment, and in particular the steps of selecting a banking operation on the basis of a statement of banking operations, of sending a request to a conversational agent associated with an instant messaging service, the apportionment request comprising at least one identifier of the user, an identifier of a group of users of an instant messaging, and an amount to be apportioned, and of receiving an instant message intended for said group of users comprising at least one balance associated with at least one member of the group.

To do this, the device 700 comprises a selection module 705 for selecting a banking operation on the basis of a statement of banking operations. In a particular embodiment, the selection module comprises a touchscreen 706 adapted to display a list of banking operations recorded on a bank account of a user. The list of operations is for example downloaded from a bank server and rendered on a screen of the device. The touchscreen is furthermore adapted to match a contact on the screen of the device with a banking operation displayed at the location where the contact is detected and to select the corresponding operation.

The device 700 comprises also a module 704 adapted to send an apportionment request to a conversational agent associated with an instant messaging service, the apportionment request comprising at least one identifier of the user, an identifier of a group of users of an instant messaging, and an amount to be apportioned. The module 704 is for example a communication interface adapted to exchange messages with other devices through a communication network. The communication interface is for example a Bluetooth, WiFi, 3G, 4G interface driven by computer program instructions configured to generate an apportionment request message confirms to an instant messaging protocol and to obtain the identifier of the user and of a user group and an amount from a memory of the device.

The communication module 704 is furthermore adapted to receive an instant message intended for said group of users and comprising at least one balance associated with at least one member of the group. To do this, the module 704 is driven by computer program instructions configured to receive a message compliant with an instant messaging protocol and to extract therefrom a balance associated with at least one member user of the instant messaging group.

According to a particular embodiment, the device is integrated into a mobile terminal of smartphone type or into a bank server.

Although the present disclosure has been described with reference to one or more examples, workers skilled in the art will recognize that changes may be made in form and detail without departing from the scope of the disclosure and/or the appended claims.

1. A method performed by an electronic device and comprising:
apportioning between a first and at least one second user of an amount of a banking operation carried out by the first user, the first and second users forming a group of users, the group of users being a chat group configured in an instant messaging service, and wherein the apportioning comprises the following acts performed by the electronic device:
receiving an apportionment request originating from a terminal of the first user, the apportionment request comprising at least:
an identifier of the first user,
an identifier of the group of users of an instant messaging,
the amount to be apportioned,
obtaining at least one characteristic of the identified group of users,
calculating according to an apportionment rule and the at least one characteristic of the group of users, an apportionment of said amount among the users belonging to the group,
updating, according to the calculated apportionment, a balance associated with each of the users of the group, and
sending an instant message addressed to at least one member of the group, the instant message comprising at least one indication according to which a balance associated with each of the users has been updated.

2. The method as claimed claim 1, in which the act of sending a message to at least one member of the group is conditioned by a prior receipt of a message originating from said at least one member of the group.

3. The method as claimed in claim 1, in which the apportionment request received furthermore comprises a subset of users belonging to said group, the apportionment being calculated for said subset of users.

4. The method as claimed in claim 1, wherein the method furthermore comprises transmitting, to a server hosting banking services of the first user, a message comprising the balances associated with the various users belonging to the group.

5. The method as claimed in claim 1, in which the instant message addressed to at least one member of the group is sent to each of the members of the group, the message comprising the balance associated with each member of the group.

6. The method as claimed in claim 1, wherein the method furthermore comprises generating and sending an instant message addressed to the members of the group, the instant message comprising an identifier of the first user and an amount of an expenditure incurred.

7. A method of requesting apportionment of an amount of a banking operation carried out by a user, the method comprising the following acts performed by a terminal of the user:
selecting a banking operation on the basis of a statement of banking operations,
sending a message requesting apportionment to a conversational agent associated with an instant messaging service, the apportionment request comprising at least:
an identifier of the user,
an identifier of a group of users of an instant messaging,
an amount to be apportioned, and
receiving an instant message intended for said group of users comprising at least one balance associated with at least one member of the group.

8. The method as claimed in claim 7, in which the act of selecting a banking operation is carried out according to a characteristic of a payment means used to carry out the banking operation.

9. The method as claimed in claim 7, wherein the method further comprises a prior act of obtaining an identifier of an instant messaging user group, the user group comprising at least the first user.

10. A device comprising:
at least one communication interface;
a processor;
a non-transitory computer-readable medium comprising instructions stored thereon, which when executed by the processor configure the device to perform acts comprising:
apportioning between a first and at least one second user of an amount of a banking operation carried out by the first user, the first and second users forming a group of users, wherein the group of users is a chat group configured in an instant messaging service and the apportioning comprises:
receiving an apportionment request through the at least one communication interface originating from a terminal of the first user, the apportionment request comprising at least:
an identifier of the first user,
an identifier of the group of users of an instant messaging,
an amount to be apportioned,
obtaining at least one characteristic of the identified group of users,
calculating an apportionment of the amount among the users of the group according to an apportionment rule and the at least one characteristic of said group,
updating, according to the calculated apportionment, a balance associated with each of the users of the group,
sending through the at least one communication interface an instant message addressed to at least one member of the group, the message comprising at least the updated balance associated with said at least one member of the group.

11. A device for requesting apportionment of an amount of a banking operation carried out by a first user, the device comprising:
at least one communication interface;
a processor;
a non-transitory computer-readable medium comprising instructions stored thereon, which when executed by the processor configure the device to perform acts comprising:
selecting a banking operation on the basis of a statement of banking operations,
sending through the at least one communication interface a message requesting apportionment to a conversational agent associated with an instant messaging service, the apportionment request comprising at least:
an identifier of the first user,
an identifier of a group of users of an instant messaging,
an amount to be apportioned, and
receiving through the at least one interface an instant message intended for said group of users comprising at least one balance associated with at least one member of the group.

12. The device according to claim 10, wherein the device is implemented in an apportionment server.

13. The device according to claim 11, wherein the device is implemented in a terminal of the first user.

14. A non-transitory information medium readable by a processor on which is recorded a computer program comprising instructions for execution of a method of apportioning between a first and at least one second user of an amount of a banking operation carried out by the first user, when the instructions are executed by a processor of an electronic device, the first and second users forming a group of users, the group of users being a chat group configured in an instant messaging service, and wherein the apportioning comprises the following acts performed by the electronic device:
receiving an apportionment request originating from a terminal of the first user, the apportionment request comprising at least:
an identifier of the first user,
an identifier of the group of users of an instant messaging,
the amount to be apportioned,
obtaining at least one characteristic of the identified group of users,
calculating according to an apportionment rule and the at least one characteristic of the group of users, an apportionment of said amount among the users belonging to the group,
updating, according to the calculated apportionment, a balance associated with each of the users of the group, and
sending an instant message addressed to at least one member of the group, the instant message comprising at least one indication according to which a balance associated with each of the users has been updated.

15. A non-transitory information medium readable by a processor on which is recorded a computer program comprising instructions for execution of a method of requesting apportionment of an amount of a banking operation carried out by a user, when the instructions are executed by a processor of a terminal of the user, the method comprising the following acts performed by the terminal:
selecting a banking operation on the basis of a statement of banking operations,
sending a message requesting apportionment to a conversational agent associated with an instant messaging service, the apportionment request comprising at least:
an identifier of the user,
an identifier of a group of users of an instant messaging,
an amount to be apportioned, and
receiving an instant message intended for said group of users comprising at least one balance associated with at least one member of the group
